(19) United States
(12) Patent Application Publication
(10) Pub. No.: US 2013/0335377 A1
(43) Pub. Date: Dec. 19, 2013

(54) NOTEBOOK TOUCH INPUT DEVICE

(71) Applicants: Tzyy-Pyng Lin, New Taipei City (TW); Fu-Kuei Chang, New Taipei City (TW); Jhih-Wun Syu, Sinjhuang City (TW); Kuei-Ying Chan, Sinjhuang City (TW)

(72) Inventors: Tzyy-Pyng Lin, New Taipei City (TW); Fu-Kuei Chang, New Taipei City (TW); Jhih-Wun Syu, Sinjhuang City (TW); Kuei-Ying Chan, Sinjhuang City (TW)

(21) Appl. No.: 13/524,718

(22) Filed: Jun. 15, 2012

(51) Int. Cl. G06F 3/041; G06F 3/042

(52) U.S. Cl. 345/175; 345/173

(57) ABSTRACT

A notebook touch input device includes a first main body, a second main body and at least one touch module. The first main body has a display module. The second main body is pivotally connected to the first main body. The first main body can be selectively closed onto the second main body or opened from the second main body. The second main body has a main surface corresponding to the display module. The touch module is disposed on the main surface and electrically connected to the second main body. The touch module includes multiple transmitters and multiple receivers arranged opposite to the transmitters. The transmitters and the receivers together define a touch space. By means of the notebook touch input device, the volume and thickness of the notebook are reduced and the notebook is more lightweight and the lifetime of the notebook is prolonged.

### BACKGROUND OF THE INVENTION

1. Field of the Invention

The present invention relates to a notebook touch input device, which can reduce the volume and weight of the notebook and prolong the lifetime of the notebook.

2. Description of the Related Art

Along with the continuous advance of information sciences and technologies, computers, notebooks and tablets have become inevitable electronic devices in daily life. The computer generally has a keyboard as an inevitable peripheral hardware device for inputting commands. Through the keyboard, a user can input characters, numerals, commands, etc.

Nowadays, there is a trend in the computer users to not only focus on the hardware devices directly related to the performances of the computer, such as central processing unit (CPU), memory, hard disk and display card, but also focus on the selection of input devices such as keyboard and mouse. This is because many computer users have gradually realized that CPU has been such developed as to have very strong performances sufficient to fulfill most domestic or office requirements. In fact, as the interactive media between the computer and the user, only the command input or pointing devices such as the keyboard and mouse are the most touched parts in use of the computer. Therefore, it is also critical to select a suitable mouse and keyboard.

The existent notebook or tablet generally has a mechanical keyboard. The mechanical keyboard includes multiple key caps, a circuit board formed with multiple circular holes arranged corresponding to the positions of the keys and a rubber sheet disposed under the circuit board. A pair of radially outward extending restriction notches is formed on the circumference of each circular hole. A circular tubular body and a pair of elastic latch hooks are connected to the bottom face of each key cap. One end of the circular tubular body passes through each circular hole of the circuit board to coaxially slidably contact with the circular hole. Also, the elastic latch hooks pass through the restriction notches of the circuit board to prevent the key cap from upward detaching out of the circular hole when coaxially sliding relative to the circular hole of the circuit board. Multiple flexible bosses are disposed on an upper face of the rubber sheet corresponding to the circular holes of the circuit board. The circular tubular bodies of the key caps can downward press the flexible bosses to downward push the conductive circuited coating positioned under the rubber sheet so as to trigger a corresponding signal. Then the flexible bosses restore to their original states to upward push the key caps back to their home positions.

At the present time, it is required that the notebook and table are designed with lightweight, slim and miniaturized structure. All the components of the computer have been thinned to a limited and cannot be further slimmed. In this case, the height of the key cap is as reduced as possible so as to reduce the total thickness of the key and further thin the total thickness of the notebook. However, according to the common specification of the notebook, the downward press travel of the key cap is required to be at least larger than a minimum value, which is generally 3 mm. That is, when inputting data, a user of the computer needs to press down the key by an operation travel (downward displacement) not less than 3 mm. This is because when inputting data with fingers, the key changing speed of the fingers is not allowed to be faster than the signal transmission speed of single key of the keyboard. This is for preventing that the user's finger presses and then leaves next key before the transmission of last signal is completed. In this case, the next signal will overlap the last signal to make the computer fail to receive the next signal. Therefore, it is necessary to keep the downward displacement of the key not less than the minimum value. In the case that the length of the elastic latch hooks is shortened, the height of the key cap is reduced to shorten the operation travel. However, this will make the key cap fail to comply with the product specification.

Accordingly, in order to meet the requirement for lightweight and slim structure, some manufacturers employ touch input device instead of the conventional mechanical keyboard structure. The touch input device is a capacitive touch input device including an outermost protection layer, (which can be a glass or acrylic layer), a middle silicon dioxide hardened coating and an innermost indium tin oxide (ITO) coating. A uniform electrical field is set up on the surface of the glass layer. By means of sensing the weak current of human body, a user can input data in a touch manner. Such touch input device can effectively greatly reduce the total thickness of the notebook. However, the cost of such touch input device is very high. Moreover, the material of such touch input device is likely to fail so that the lifetime of the touch input device is shortened.

According to the above, the conventional technique has the following shortcomings:

1. The volume is too large and the weight is too heavy.

2. The cost is high.

3. The lifetime is shorter.

### SUMMARY OF THE INVENTION

It is therefore a primary object of the present invention to provide a notebook touch input device. By means of the notebook touch input device, the volume and thickness of the notebook are greatly reduced and the notebook is more lightweight.

It is a further object of the present invention to provide the above notebook touch input device, which can prolong the lifetime of the notebook.

To achieve the above and other objects, the notebook touch input device of the present invention includes a first main body, a second main body and at least one touch module. The first main body has a display module disposed on the first main body. The second main body is pivotally connected to the first main body. The first main body can be selectively closed onto the second main body or opened from the second main body. The second main body has a main surface corresponding to the display module. The touch module is disposed on the main surface and electrically connected to the second main body. The touch module includes multiple transmitters and multiple receivers arranged opposite to the transmitters. The transmitters and the receivers together define a touch space.

In the above notebook touch input device, the transmitters and receivers are oppositely disposed on the main surface to define the touch space instead of the conventional keyboard or pointing device. Therefore, the shortcoming caused by the conventional keyboard and pointing device that the notebook has a too large volume and occupies too much room is eliminated. By means of the notebook touch input device of the present invention, the volume and thickness of the notebook are greatly reduced and the notebook is more lightweight. In addition, the lifetime of the notebook is prolonged.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1A is a perspective exploded view of a first embodiment of the notebook touch input device of the present invention;

FIG. 1B is a perspective assembled view of the first embodiment of the notebook touch input device of the present invention;

FIG. 1C is an enlarged view of a part of the first embodiment of the notebook touch input device of the present invention;

FIG. 1D is a perspective view of the first embodiment of the notebook touch input device of the present invention;

FIG. 2 is a perspective view showing the operation of the first embodiment of the notebook touch input device of the present invention;

FIG. 3A is a perspective view of a second embodiment of the notebook touch input device of the present invention;

FIG. 3B is another perspective view of the second embodiment of the notebook touch input device of the present invention;

FIG. 4 is a perspective view of a third embodiment of the notebook touch input device of the present invention.

### DETAILED DESCRIPTION OF THE PREFERRED EMBODIMENTS

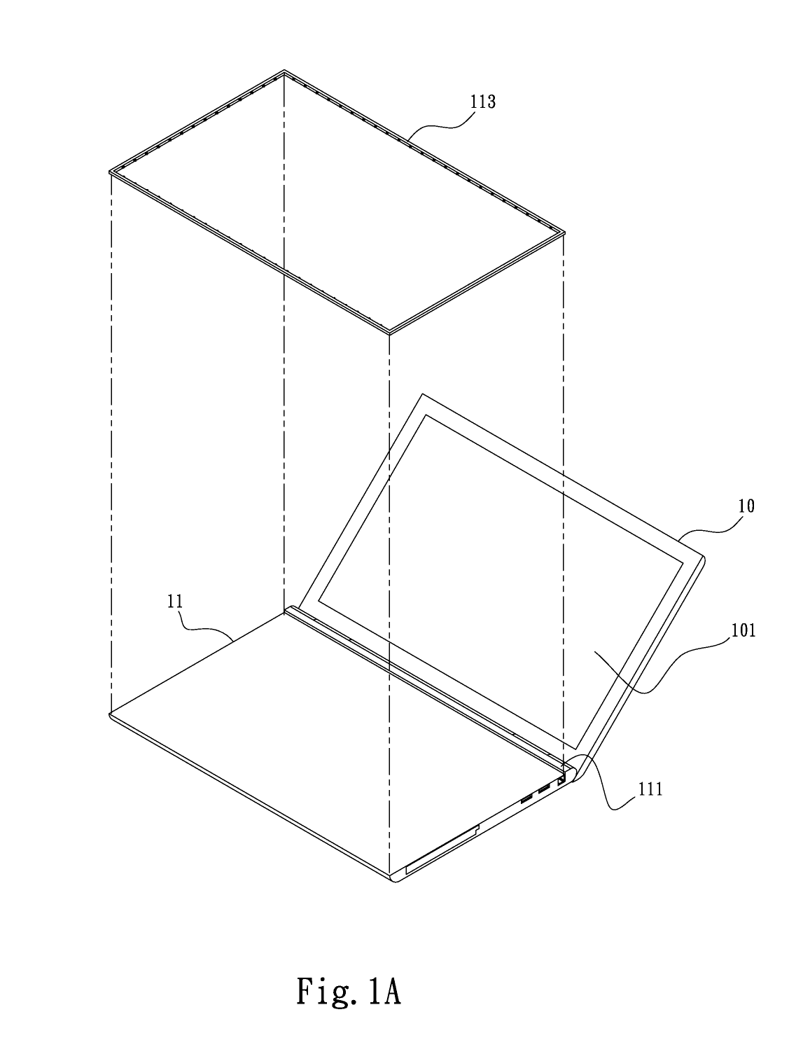

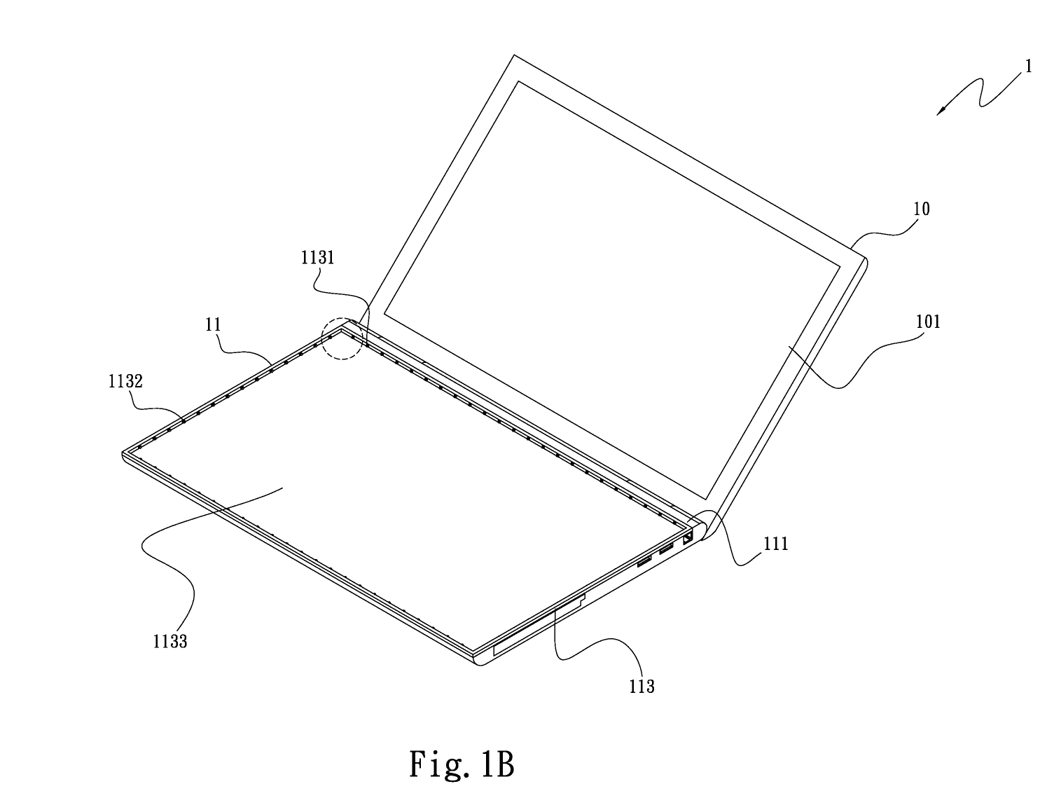

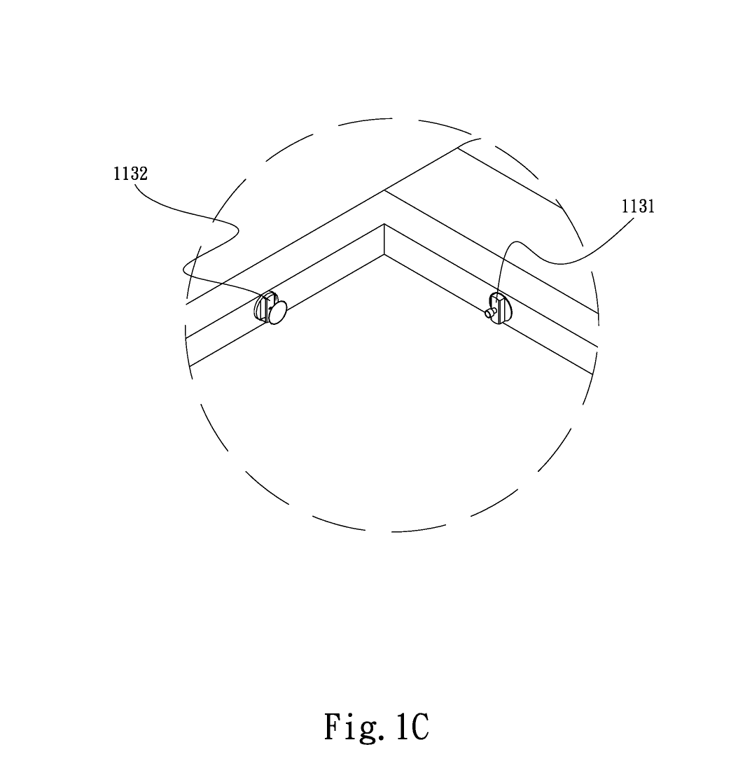

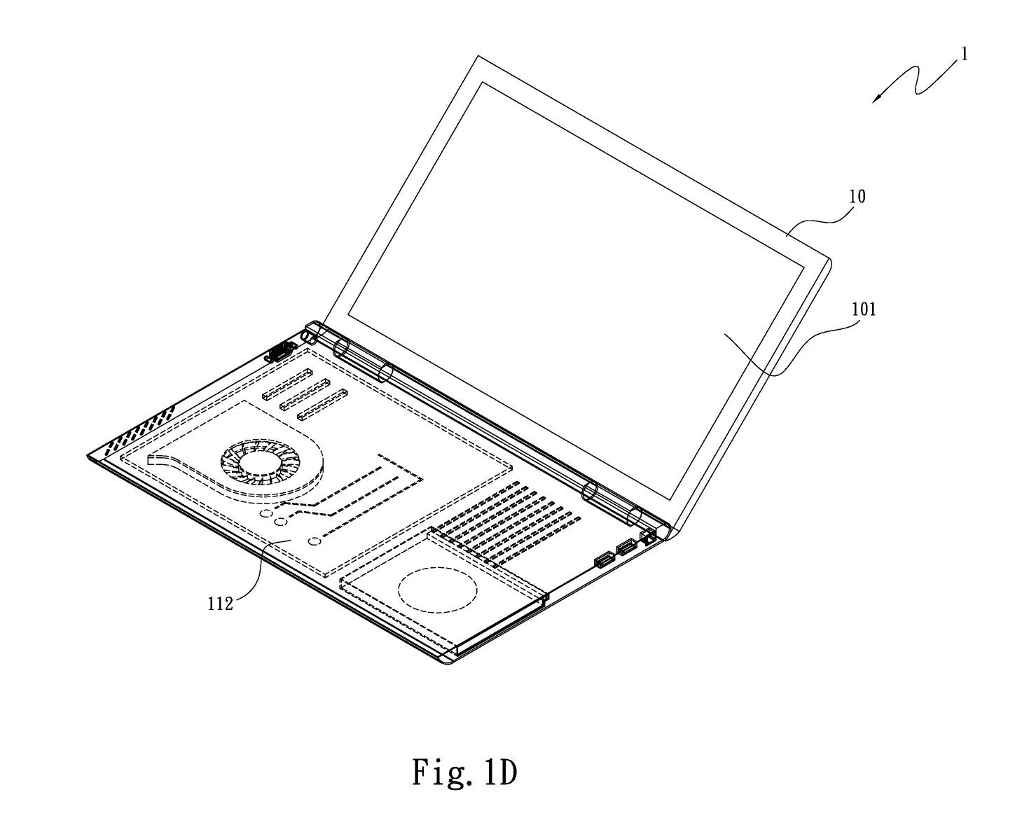

Please refer to FIGS. 1A, 1B, 1C and 1D. FIG. 1A is a perspective exploded view of a first embodiment of the notebook touch input device of the present invention. FIG. 1B is a perspective assembled view of the first embodiment of the notebook touch input device of the present invention. FIG. 1C is an enlarged view of a part of the first embodiment of the notebook touch input device of the present invention. FIG. 1D is a perspective view of the first embodiment of the notebook touch input device of the present invention. According to the first embodiment, the notebook touch input device 1 of the present invention includes a first main body 10, a second main body 11 and at least one touch module 113. The first main body 10 has a display module 101 disposed on the first main body 10. The second main body 11 is pivotally connected to the first main body 10. The first main body 10 can be selectively closed onto the second main body 11 or opened from the second main body 11. The second main body 11 has a main surface 111 corresponding to the display module 101.

The touch module 113 is disposed on the main surface 111 and electrically connected to the second main body 11. The touch module 113 includes multiple transmitters 1131 and multiple receivers 1132 arranged opposite to the transmitters 1131. The transmitters 1131 and the receivers 1132 together define a touch space 1133. The second main body 11 includes a mainframe module 112 therein. The mainframe module 112 is electrically connected to the display module 101 and the touch module 113.

The transmitters 1131 transmit signals to the receivers 1132 in an optical form for the receivers 1132 to receive. The signals in the optical form can be infrared signals.

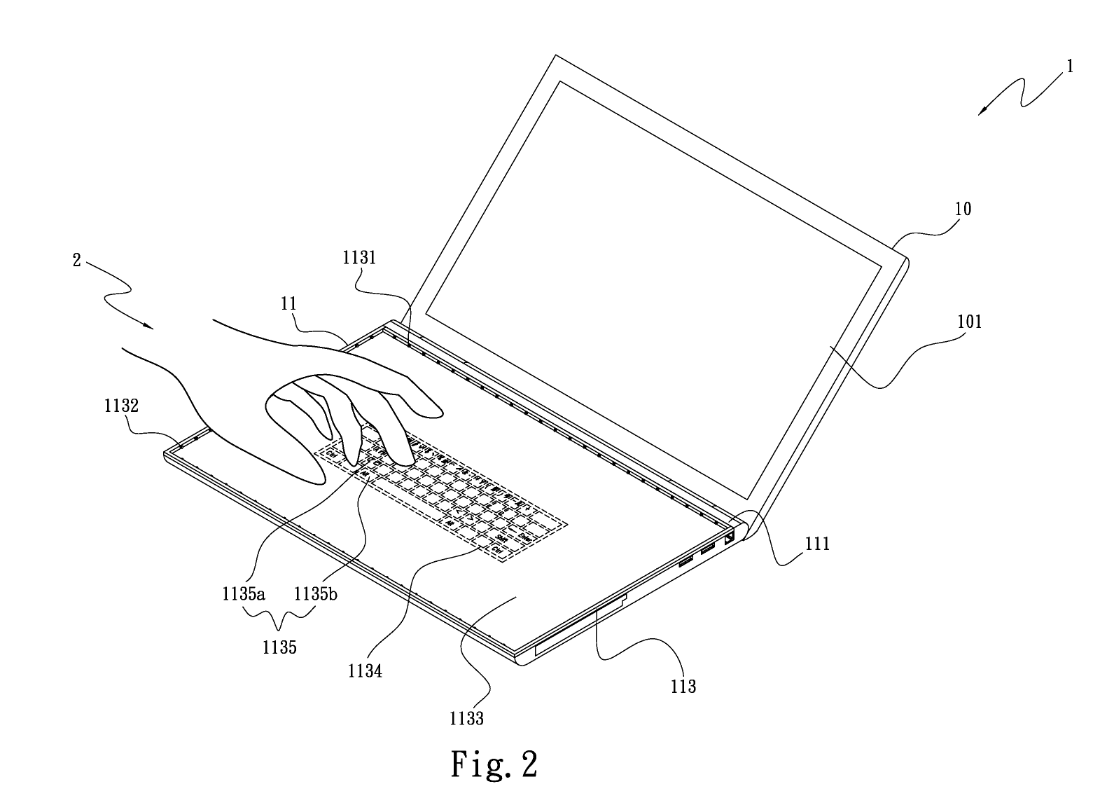

Please now refer to FIG. 2, which is a perspective view showing the operation of the first embodiment of the notebook touch input device 1 of the present invention. The touch space 1133 forms a virtual keyboard 1134 having multiple virtual keys 1135. The virtual keys 1135 have different language systems. Also, the virtual keys 1135 include multiple virtual symbol keys 1135a and multiple virtual character keys 1135b. According to the above structure of the notebook touch input device 1 of the present invention, the transmitters 1131 and the receivers 1132 together define the touch space 1133. When a user uses the notebook, an object 2 (such as the user's finger or a pen or any other operation means) touches the touch module 113 on the main surface 111 of the second main body 11. In the case that the signals transmitted from the transmitters to the receivers are interrupted by the external object 2, the character or symbol needed by the user is located and identified and is displayed on the display module 101 of the first main body 10. Accordingly, the shortcoming caused by the conventional mechanical keyboard that the notebook has a too large volume and occupies too much room is eliminated. By means of the notebook touch input device 1 of the present invention, the volume and thickness of the notebook are greatly reduced so that the notebook is more lightweight. In addition, the transmitters 1131 transmit signals to the receivers 1132 in an optical form for the receivers 1132 to receive instead of the conventional capacitive touch input device. Therefore, the problem of material failure is overcome and the lifetime of the notebook is greatly prolonged.

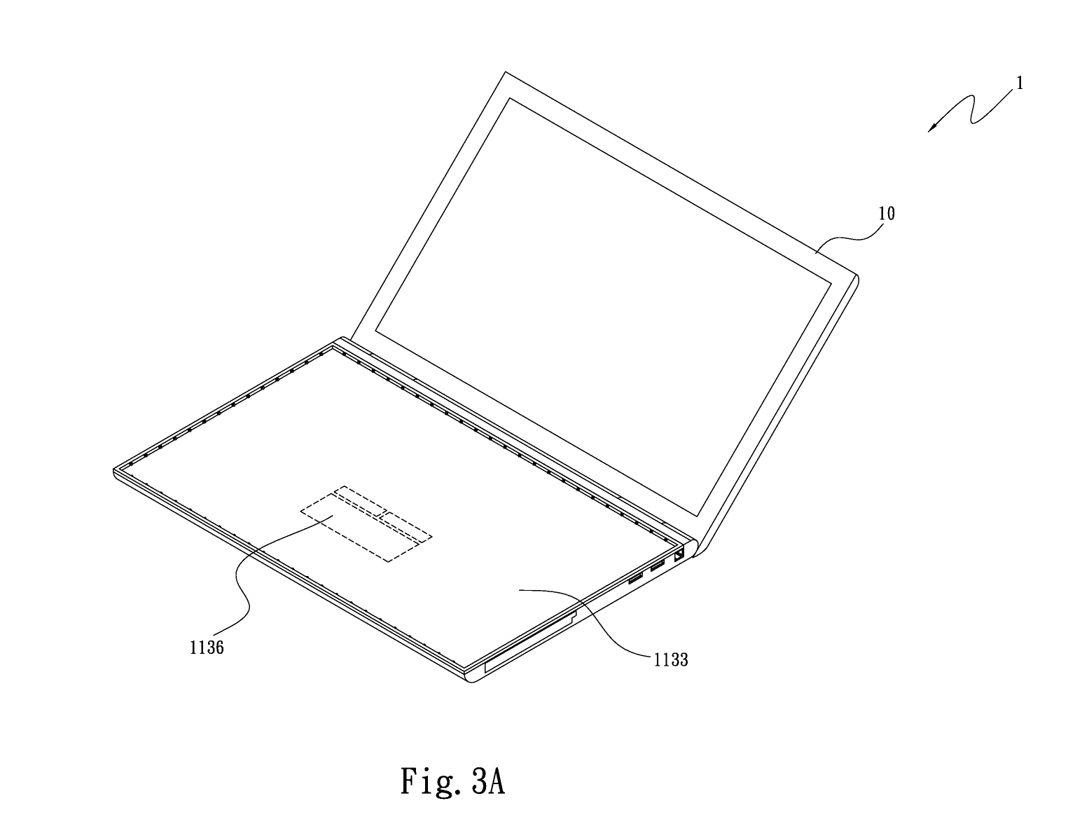

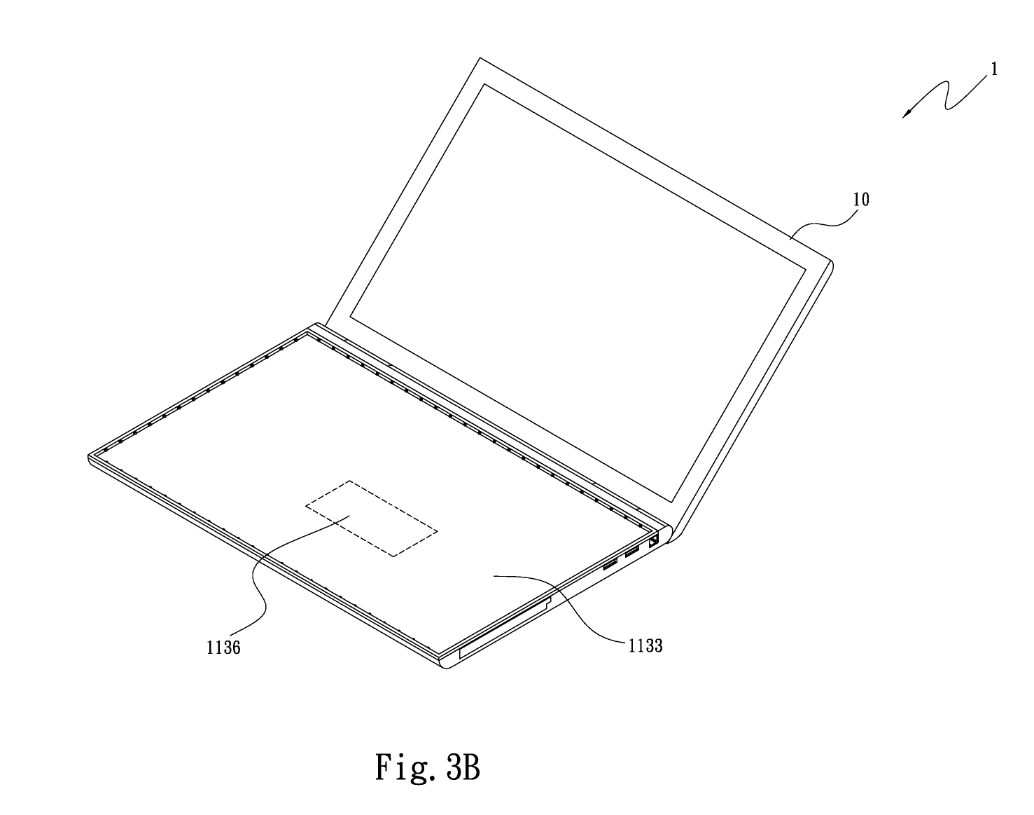

Please now refer to FIGS. 3A and 3B. FIG. 3A is a perspective view of a second embodiment of the notebook touch input device of the present invention. FIG. 3B is another perspective view of the second embodiment of the notebook touch input device of the present invention. The second embodiment is partially identical to the first embodiment in components and connection relationship between the components and thus will not be repeatedly described hereinafter. The second embodiment is mainly different from the first embodiment in that the touch space 1133 can be switchable with a virtual mouse 1136 or a virtual tablet 1137. This can also reduce the volume and thickness of the notebook and make the notebook more lightweight.

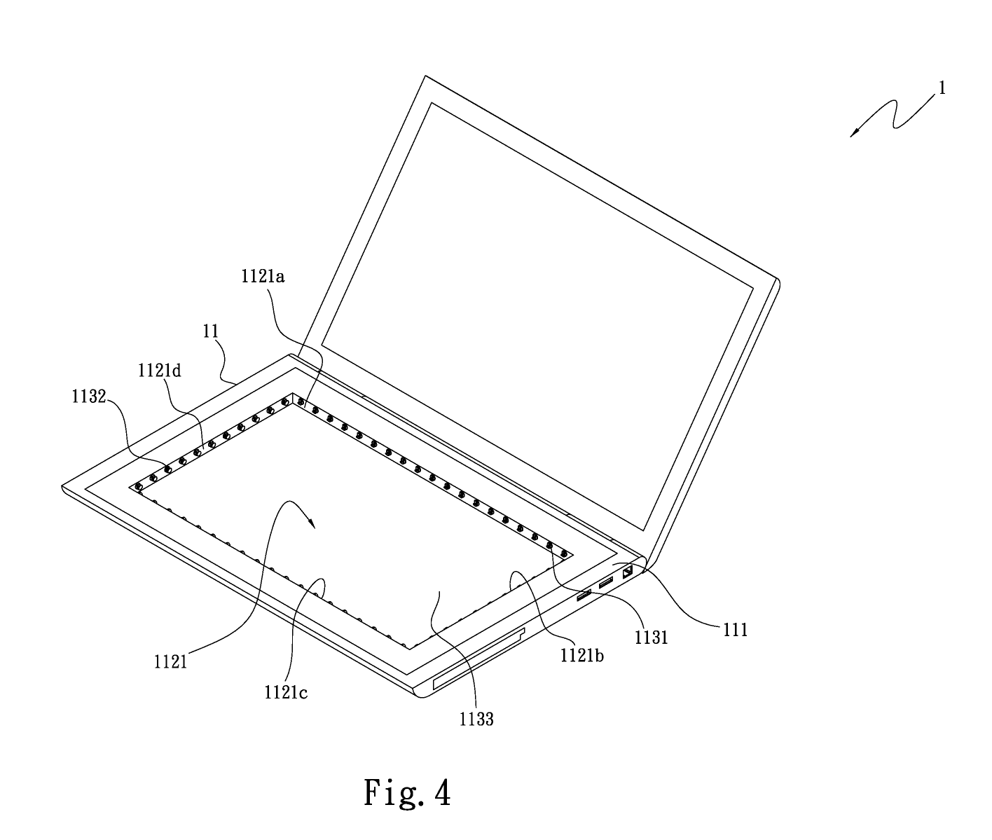

Please now refer to FIG. 4, which is a perspective view of a third embodiment of the notebook touch input device of the present invention. The third embodiment is partially identical to the first embodiment in components and connection relationship between the components and thus will not be repeatedly described hereinafter. The third embodiment is mainly different from the first embodiment in that the second main body 11 further has a sink 1121 recessed on the main surface 111. The sink 1121 has a first sidewall 1121a, a second sidewall 1121b, a third sidewall 1121c opposite to the first sidewall 1121a and a fourth sidewall 1121d opposite to the second sidewall 1121b. The transmitters 1131 are respectively disposed on the first and second sidewalls 1121a, 1121b and the receivers 1132 are respectively disposed on the third and fourth sidewalls 1121c, 1121d opposite to the transmitters 1131 disposed on the first and second sidewalls 1121a, 1121b. According to the above structure, the transmitters 1131 transmit signals to the receivers 1132 in an optical form and the transmitters 1131 and the receivers 1132 together define the touch space 1133 instead of the conventional mechanical keyboard of the conventional notebook. Therefore, the shortcoming caused by the conventional mechanical keyboard that the notebook has a too thick thickness and occupies too much room is eliminated. By means of the notebook touch input device 1 of the present invention, the volume and thickness of the notebook are greatly reduced so that the notebook is more lightweight.

In comparison with the conventional technique, the present invention has the following advantages:

1. The volume of the notebook is reduced and the notebook is more lightweight.

2. The cost is lower.

3. The lifetime is longer.

The present invention has been described with the above embodiments thereof and it is understood that many changes and modifications in the above embodiments can be carried out without departing from the scope and the spirit of the invention that is intended to be limited only by the appended claims.

What is claimed is:

1. A notebook touch input device comprising:
a first main body having a display module disposed on the first main body;
a second main body pivotally connected to the first main body, whereby the first main body can be selectively closed onto the second main body or opened from the second main body, the second main body having a main surface corresponding to the display module; and
at least one touch module disposed on the main surface and electrically connected to the second main body, the touch module including multiple transmitters and multiple receivers arranged corresponding to the transmitters, the transmitters and the receivers together defining a touch space.

2. The notebook touch input device as claimed in claim 1, wherein the second main body includes a mainframe module therein, the mainframe module being electrically connected to the display module and the touch module.

3. The notebook touch input device as claimed in claim 1, wherein the second main body further has a sink recessed on the main surface, the sink having a first sidewall, a second sidewall, a third sidewall opposite to the first sidewall and a fourth sidewall opposite to the second sidewall, the transmitters being respectively disposed on the first and second sidewalls and the receivers being respectively disposed on the third and fourth sidewalls opposite to the transmitters disposed on the first and second sidewalls.

4. The notebook touch input device as claimed in claim 1, wherein the transmitters transmit signals to the receivers in an optical form for the receivers to receive.

5. The notebook touch input device as claimed in claim 4, wherein the signals in the optical form are infrared signals.

6. The notebook touch input device as claimed in claim 1, wherein the touch space is switchable between a virtual keyboard, a virtual mouse and a virtual tablet.

7. The notebook touch input device as claimed in claim 6, wherein the virtual keyboard has multiple virtual keys.

8. The notebook touch input device as claimed in claim 7, wherein the virtual keys have different language systems.

9. The notebook touch input device as claimed in claim 8, wherein the virtual keys include multiple virtual symbol keys and multiple virtual character keys.
